(19) United States
(12) Patent Application Publication
(10) Pub. No.: US 2024/0121633 A1
(43) Pub. Date: Apr. 11, 2024

(54) METHOD AND APPARATUS FOR MONITORING AND MANAGING PERFORMANCE OF ARTIFICIAL NEURAL NETWORK MODEL FOR AIR INTERFACE

(71) Applicant: ELECTRONICS AND TELECOMMUNICATIONS RESEARCH INSTITUTE, Daejeon (KR)

(72) Inventors: Han Jun PARK, Daejeon (KR); Yong Jin KWON, Daejeon (KR); An Seok LEE, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 18/475,414

(22) Filed: Sep. 27, 2023

(30) Foreign Application Priority Data
Sep. 30, 2022 (KR) 10-2022-0124966
May 30, 2023 (KR) 10-2023-0069214

(51) Int. Cl. H04W 24/02; H04W 24/08

(52) U.S. Cl. CPC H04W 24/02; H04W 24/08

(57) ABSTRACT

A method of monitoring and managing performance of an artificial neural network model for an air interface may comprise: receiving, by a network (NW) including a communication node performing a function of monitoring and managing performance of an artificial neural network model, a performance metric of the artificial neural network model from a user equipment (UE); and controlling, by the communication node, activation or deactivation of the artificial neural network model according to the performance metric, wherein the artificial neural network model is activated to improve a main performance metric of a mobile communication system including the communication node and the UE connected through an air interface.

### CROSS-REFERENCE TO RELATED APPLICATIONS

This application claims priority to Korean Patent Applications No. 10-2022-0124966, filed on Sep. 30, 2022, and No. 10-2023-0069214, filed on May 30, 2023, with the Korean Intellectual Property Office (KIPO), the entire contents of which are hereby incorporated by reference.

### BACKGROUND

### 1. Technical Field

Example embodiments of the present disclosure relate in general to a method and apparatus for monitoring and managing performance of an artificial neural network model in which whether ground truth (GT) is necessary is taken into consideration for a user equipment (UE) to evaluate performance of an artificial neural network when the artificial neural network for wireless communication is used in a mobile communication system including a next generation node base station (gNB) and one or more UEs.

### 2. Related Art

The Third Generation Partnership Project (3GPP), which is an international standardization organization, selected artificial intelligence (AI)/machine learning (ML) application methods for a new radio (NR) air interface as a future study item (SI) of Release 18. The purpose of the SI is to determine use cases where AI/ML applications may be used in an NR air interface and check performance benefit and the like resulting from the AI/ML applications in each use case. Representative use cases are channel state information (CSI) feedback enhancement, beam management, positioning accuracy enhancement, and the like.

CSI feedback is a CSI report made by a user equipment (UE) so that a next generation node base station (gNB) may apply a transmission technique, such as multiple-input multiple-output (MIMO) or the like, or precoding in a mobile communication system. A fifth generation (5G) NR standard defined by the 3GPP supports feedback information, such as a channel quality indicator (CQI), a precoding matrix indicator (PMI), a rank indicator (RI), and the like, in connection with a CSI feedback method. To effectively support a transmission technique, such as multi-user MIMO (MU-MIMO) or the like, in an NR system, discussions on improving a CSI feedback technique are ongoing.

Specifically, a 3GPP NR system supports two types of codebooks to transmit PMI information. The codebooks are named type 1 codebook and type 2 codebook. Type 1 codebook represents a beam group as an oversampled discrete Fourier transform (DFT) matrix and has a structure in which one beam is selected from the beam group and transmitted. Meanwhile, type 2 codebook has a structure in which a plurality of beams are selected and information is transmitted in the form of a linear combination of the selected beams.

Type 2 codebook is evaluated as a structure more suitable for supporting a transmission technique, such as MU-MIMO or the like, than type 1 codebook but has a drawback in that the load of CSI feedback significantly increases due to the complex codebook structure.

In connection with the above problem, research is ongoing on a method of obtaining a compressed latent expression of a MIMO channel using an autoencoder which is a latest deep learning technique.

Specifically, beam management is a process of assigning transmission beam and/or reception beam resources when a gNB and UE in a mobile communication system may apply analog beams and the like to transmission and reception using a spatial filter. According to the 5G NR standard defined by the 3GPP, beam management supports a gNB and/or UE to search for optimal beam resources by transmitting a reference signal, such as a synchronization signal block (SSB), a CSI-reference signal (RS), and/or the like, in a plurality of analog beam directions.

However, a method in which a UE searches for a plurality of analog beam directions as described above and reports an optimal one of found beam directions to a transmitter every time may cause a delay and a signal transmission load. In connection with this problem, research is underway to predict next beam information on the basis of previous beam information using reinforcement learning which is an AI/MR technique, or infer high-resolution beam information from low-resolution beam information using supervised learning.

Positioning is a technique for measuring the location of a specific UE in a mobile communication system. According to the 5G NR standard defined by the 3GPP, a positioning reference signal (PRS) is transmitted so that a UE reports a reference signal time difference (RSTD), and then a positioning technique, such as observed time difference of arrival (OTDOA) or the like, is applied.

Lately, demands for accuracy in positioning have increased, and in view of the above, research is underway to increase accuracy in measurement values for positioning by applying an AUML technique to radio frequency (RF) fingerprinting.

Meanwhile, when an artificial neural network is employed in a mobile communication system including a gNB and UE as described above, life cycle management (LCM) for the artificial neural network may be necessary.

LCM for an artificial neural network is a process of creating and utilizing the artificial neural network. An LCM process defined by the 3GPP includes data collection, model training, a model inference operation, model deployment, model activation, model deactivation, model selection, model monitoring, model transfer, and the like.

For example, LCM may be associated with a life cycle represented in order of data collection, model training, model deployment, model activation, a model inference operation, and model monitoring.

In connection with the model activation process, there are existing transmission and reception algorithms commonly used in commercial mobile communication systems, such as fourth generation (4G) systems and 5G systems. Accordingly, in the case of performing a specific wireless communication function using an artificial neural network as described above, it may be preferable to selectively activate the artificial neural network only when the artificial neural network is determined to have higher performance than the existing transmission and reception algorithms.

Performance metrics of a case of utilizing an artificial neural network in wireless communication may be roughly classified into two types. The first type of performance metric is model inference performance (MIP) of an artificial neural network, and the second type of performance metric is a key performance indicator (KPI).

When an artificial neural network is employed, it is necessary to consider the former MIP a new performance metric. For example, in the case of supervised learning, MIP of the artificial neural network may be the difference between an output inferred from input data and ground truth (GT) for the input data. However, in many mobile communication systems including a gNB and UE, it is difficult to obtain GT for input data, or the cost of obtaining GT is considerable.

For example, it is assumed that the unmeasured strength of received beams is estimated from the measured strength of received beams in a spatial area. In this case, unless a gNB intentionally transmits measurement resources for all beams, UE is not aware of GT for the unmeasured strength of the received beams.

As another example, it is assumed that a UE estimates CSI on a time axis. The UE estimates and reports CSI for a future point in time. Then, a gNB transmits reference sources for CSI measurement at the future point in time, and the UE is required to perform CSI calculation using the sources to obtain GT for the estimation. However, when reference sources for CSI measurement are unnecessarily transmitted to acquire GT, costs or overhead may increase more than the expected benefit.

However, when CSI is compressed using an artificial neural network, input data is directly applied as GT because the artificial neural network is an autoencoder for self-supervised learning. Accordingly, it is possible to acquire GT. In other words, in the case of ensuring MIP of an artificial neural network in a mobile communication system, GT may or may not be used depending on the configuration of the artificial neural network and support from a gNB.

Therefore, in the field of data science, discussions are ongoing on a method of estimating performance of an artificial neural network model without GT. For example, when there is low correlation between training data for an artificial neural network and measured data, performance degradation proportionate to the correlation may be expected. Since a function of monitoring performance of an artificial neural network without GT requires additional complexity of implementation and additional calculation, whether the function is supported may vary depending on the capability of UE.

### SUMMARY

Accordingly, example embodiments of the present disclosure are provided to substantially obviate one or more problems due to limitations and disadvantages of the related art.

Example embodiments of the present disclosure provide a method and apparatus for monitoring and managing performance of an artificial neural network model for an air interface in which, when a user equipment (UE) may create and/or utilize at least one artificial neural network for a specific function in a mobile communication system including a gNB and at least one UE, the UE separately reports the capability of providing a model performance metric of an artificial neural network based on ground truth (GT), that is, an inference performance metric, and the capability of providing a model performance metric of an artificial neural network not based on GT to the gNB, the gNB requests a report on a model performance metric of the artificial neural network from the UE, receives a performance metric report based on GT from the UE, and transmits measurement resources for acquiring GT to the UE, and the UE reports a model performance metric of the artificial neural network corresponding to the request from the gNB to the gNB.

Example embodiments of the present disclosure also provide a method and apparatus for monitoring and managing performance of an artificial neural network model for an air interface in which model performance of an artificial neural network, that is, inference performance, of a case where GT is used for the artificial neural network and that of a case where GT is not used are separately reported in a mobile communication system including a gNB and at least one UE so that the gNB can efficiently activate and deactivate the artificial neural network.

According to a first exemplary embodiment of the present disclosure, a method of monitoring and managing performance of an artificial neural network model for an air interface may comprise: receiving, by a network (NW) including a communication node performing a function of monitoring and managing performance of an artificial neural network model, a performance metric of the artificial neural network model from a user equipment (UE); and controlling, by the communication node, activation or deactivation of the artificial neural network model according to the performance metric, wherein the artificial neural network model is activated to improve a main performance metric of a mobile communication system including the communication node and the UE connected through an air interface.

The UE may estimate performance of the artificial neural network model using an optimal transport dataset distance (OTDD).

The method may further comprise acquiring a model inference performance report capability of the artificial neural network model from the UE.

The acquiring of the model inference performance report capability may comprise receiving information representing the model inference performance report capability or information representing that the artificial neural network model has a model inference performance report function from the UE.

The method may further comprise selectively requesting a performance metric report of the artificial neural network model based on ground truth (GT) or not based on the GT from the UE with reference to the model inference performance report capability according to whether the UE uses the GT in evaluating model inference performance.

The receiving of the performance metric may comprise receiving a validity measure of a training dataset for the artificial neural network model as a performance metric of the artificial neural network model.

The method may further comprise, before the receiving of the performance metric, repeatedly transmitting ground truth (GT) measurement resources for evaluating inference performance of the artificial neural network model to the UE, wherein the receiving of the performance metric comprises receiving a performance metric of the artificial neural network model measured at a plurality of transmission opportunities to use the GT measurement resources.

The method may further comprise receiving information on UE performance estimated on the basis of the inference performance of the artificial neural network model from the UE.

The method may further comprise requesting a performance metric report of the artificial neural network model from the UE.

The requesting of the performance metric report may be performed by the communication node when a trigger condition is preset between the NW or the communication node and the UE and the trigger condition is satisfied because performance of the artificial neural network model rises to or above a certain level or falls to or below the certain level.

The method may further comprise receiving a performance metric report of the artificial neural network model or a recommendation to activate or deactivate the artificial neural network model from the UE when a trigger condition is preset between the NW or the communication node and the UE and the trigger condition is satisfied because performance of the artificial neural network model rises to or above a certain level or falls to or below the certain level.

The controlling of the activation or deactivation of the artificial neural network model may comprise controlling the activation or deactivation of the artificial neural network model in response to the performance metric report or the recommendation to activate or deactivate the artificial neural network model.

The trigger condition may be differentially set according to whether the artificial neural network model is activated or deactivated.

According to a second exemplary embodiment of the present disclosure, an apparatus for monitoring and managing performance of an artificial neural network model for an air interface may comprise a processor installed in a communication node connected to a user equipment (UE) through an air interface and configured to execute a program command for monitoring and managing performance of an artificial neural network model. The processor may perform, according to the program command, operations of: receiving a performance metric of the artificial neural network model from the UE; and controlling activation or deactivation of the artificial neural network model according to the performance metric, and the artificial neural network model is activated to improve a main performance metric of a network (NW) or a mobile communication system including the communication node and the UE connected through the air interface.

The processor may further perform an operation of acquiring a model inference performance report capability of the artificial neural network model from the UE, wherein the operation of acquiring the model inference performance report capability may comprise receiving information representing the model inference performance report capability or information representing that the artificial neural network model has a model inference performance report function from the UE.

The processor may further perform an operation of determining whether the UE uses ground truth (GT) in evaluating model inference performance with reference to the model inference performance report capability and selectively requesting a performance metric report of the artificial neural network model based on the GT or not based on the GT from the UE.

In the operation of receiving the performance metric, the processor may receive a validity measure of a training dataset for the artificial neural network model as a performance metric of the artificial neural network model.

Before the operation of receiving the performance metric, the processor may further perform an operation of repeatedly transmitting ground truth (GT) measurement resources for evaluating inference performance of the artificial neural network model to the UE, wherein, in the operation of receiving the performance metric, the processor may receive a performance metric of the artificial neural network model measured at a plurality of transmission opportunities to use the GT measurement resources.

The processor may further perform an operation of requesting a performance metric report of the artificial neural network model from the UE, wherein the operation of requesting the performance metric report may be performed by the communication node when a trigger condition is preset between the NW or the communication node and the UE and the trigger condition is satisfied because performance of the artificial neural network model rises to or above a certain level or falls to or below the certain level.

The processor may further perform an operation of receiving a performance metric report of the artificial neural network model or a recommendation to activate or deactivate the artificial neural network model from the UE when a trigger condition is preset between the NW or the communication node and the UE and the trigger condition is satisfied because performance of the artificial neural network model rises to or above a certain level or falls to or below the certain level, and in the operation of controlling the activation or deactivation of the artificial neural network model, the processor may control the activation or deactivation of the artificial neural network model in response to the performance metric report or the recommendation to activate or deactivate the artificial neural network model.

According to the present disclosure, it is possible to provide an apparatus and method for monitoring and managing performance of an artificial neural network model, the method including a process in which, when UE may create and/or utilize at least one artificial neural network for a specific function in a mobile communication system including a gNB and at least one UE, the UE separately reports the capability of providing a model performance metric of an artificial neural network based on GT and the capability of providing a model performance metric of an artificial neural network not based on GT to the gNB, the gNB requests a report on a model performance metric of the artificial neural network from the UE and transmits measurement resources for acquiring GT when the UE reports the performance metric based on GT, and the UE reports a model performance metric of the artificial neural network corresponding to the request from the gNB to the gNB.

Also, according to the present disclosure, it is possible to provide an apparatus and method for monitoring and managing performance of an artificial neural network model in which model performance or inference performance of an artificial neural network of a case where GT is used for the artificial neural network and that of a case where GT is not used are separately reported in a mobile communication system including a gNB and at least one UE so that the gNB can efficiently activate and deactivate the artificial neural network.

As an example, when a UE does not have the capability of providing a model performance indicator of an artificial neural network, a gNB may be configured to activate or deactivate an artificial neural network of the UE through trial and error. Also, when a UE has the capability of providing a model performance indicator of an artificial neural network, a gNB may request model performance of an artificial neural network from the UE or cause the UE to report performance of an artificial neural network when the UE has a certain level of performance, and determine whether to activate or deactivate the artificial neural network on the basis of the performance information.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIGS. 3A to 3C are diagrams of types of provided inference performance metrics of an artificial neural network that may be employed in a method for monitoring and managing performance of an artificial neural network model (hereinafter “management method”) according to an example embodiment of the present disclosure.

FIG. 4 is a conceptual diagram illustrating a model deactivation instruction and wireless transmission performance feedback process of a gNB that may be employed in a management method of the present disclosure.

FIG. 5 is a conceptual diagram illustrating an artificial neural network model performance request and response process that may be employed in a management method of the present disclosure.

FIG. 6 is a conceptual diagram illustrating a process of transmitting measurement resources for acquiring GT when artificial neural network model performance is requested which may be employed in a management method of the present disclosure.

FIG. 7 is a conceptual diagram illustrating an event-based artificial neural network model performance report process that may be employed in a management method of the present disclosure.

FIG. 8 is a conceptual diagram illustrating another event-based artificial neural network model performance report process that may be employed in a management method of the present disclosure.

FIG. 9 is a conceptual diagram illustrating a process that may be employed in a management method of the present disclosure in which a gNB or UE triggers activation or deactivation of an artificial neural network model.

FIG. 10 is a conceptual diagram illustrating another process that may be employed in a management method of the present disclosure in which a gNB or UE triggers activation or deactivation of an artificial neural network model.

FIG. 11 is a block diagram illustrating a random access network (RAN) intellectualization function of an artificial neural network which may be employed in a management method of the present disclosure.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A wireless communication network to which embodiments according to the present disclosure are applied will be described. The wireless communication network to which the embodiments according to the present disclosure are applied is not limited to the contents described below, and the embodiments according to the present disclosure may be applied to various wireless communication networks.

Hereinafter, a method of monitoring and managing performance of an artificial neural network model according to the present disclosure will be described mainly in view of a downlink of a mobile communication system including a next generation node base station (gNB) and a user equipment (UE) for convenience of description. However, the method according to the present disclosure may be extensively applied to any wireless communication system including a transmitter and a receiver.

Also, in the method according to the present disclosure, artificial intelligence (AI)/machine learning (ML) models may be classified as a one-sided AI/ML model and a two-sided AI/ML model according to the location of a network node where an inference operation is performed.

The one-sided AI/ML model is an AI/ML model which makes an inference only in a UE or network (NW). The case of making an inference only in a UE may be classified as a UE-sided AI/ML model, and the case of making an inference only in an NW may be classified as a network-sided AI/ML model.

The two-sided AI/ML model is a pair of AWL models which perform joint reasoning. Joint reasoning includes AI/ML inference jointly made by a UE and an overall NW. For example, a first part of inference may be performed by the UE, and another part may be performed by a gNB, or vice versa.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

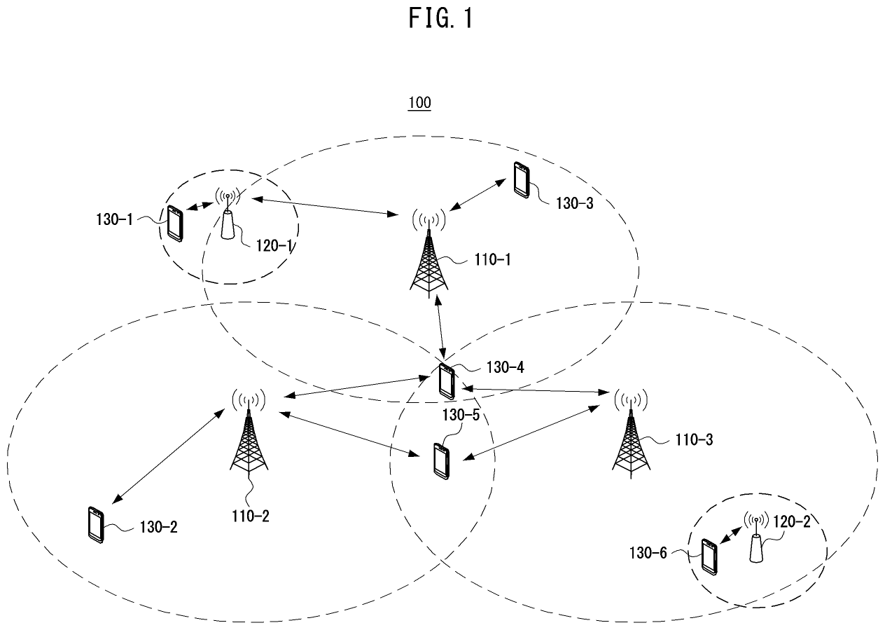

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

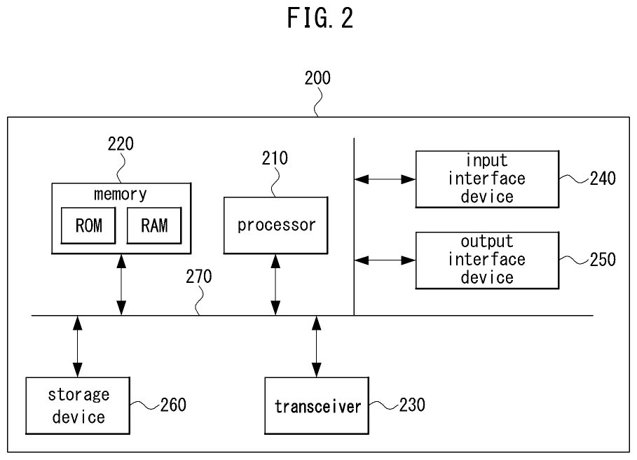

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

### First Example Embodiment

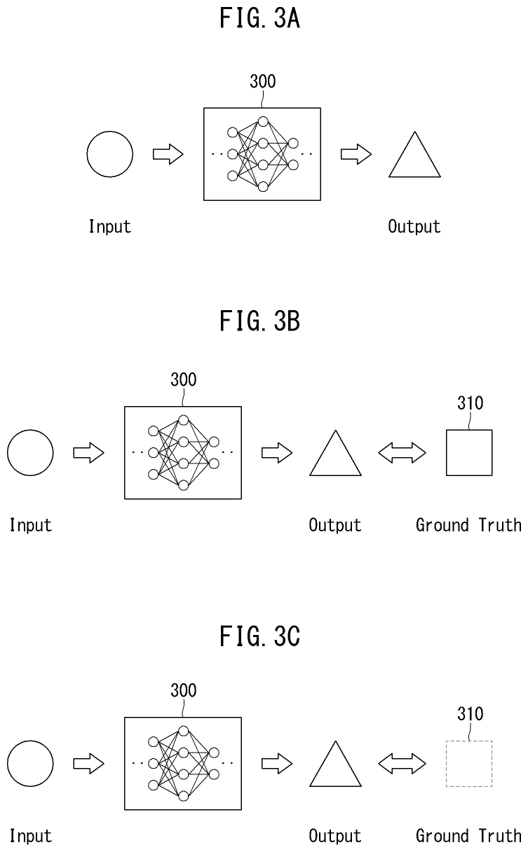

FIGS. 3A to 3C are diagrams of types of provided inference performance metrics of an artificial neural network that may be employed in a method for monitoring and managing performance of an artificial neural network model (hereinafter “management method”) according to an example embodiment of the present disclosure.

Referring to FIGS. 3A to 3C, in the management method according to this example embodiment, when an artificial neural network for wireless communication is applied to a mobile communication system including a gNB and UE and the UE may create and/or utilize at least one artificial neural network for a specific function, the UE may provide at least one of type 0, type 1, type 2, type 2-1, type 2-2, and the like to the gNB as a model performance metric of each artificial neural network for the specific function. Model performance metrics may also be referred to as “inference performance metrics” or “model inference performance metrics.”

Specifically, as shown in FIG. 3A, type 0 represents that a UE or gNB employing an artificial neural network model 300 which receives an input and generates an output does not provide a model performance metric of the artificial neural network, that is, an inference performance metric.

Type 1 represents that an artificial neural network model 300 provides a model performance metric of the artificial neural network, that is, an inference performance metric, using GT 310 as shown in FIG. 3B.

Type 2 represents that an artificial neural network model 300 provides an estimated model performance metric of the artificial neural network, that is, an estimated inference performance metric, without using GT 310 as shown in FIG. 3C.

Type 1 or type 2 may include type 2-1 and type 2-2. Type 2-1 is a type of providing an estimated value of model performance of an artificial neural network, and type 2-2 is a type of providing a validity measure of a training dataset.

Type 0, type 1, and type 2 described above may be referred to as function A, function B, and function C or capability A, capability B, and capability C, respectively.

Also, according to the management method, when a UE reports UE capability information, types of provided model performance metrics of an artificial neural network may be included in the UE capability information and reported to a gNB. Model performance may be a performance metric of an inference operation based on an artificial neural network model. Also, the UE may support one or more performance metric types. For example, the UE may have the capability of providing both type 1 and type 2.

In a mobile communication system including a gNB and UE according to the 3GPP standard, assuming that the UE utilizes an artificial neural network for wireless communication, an accurate method of measuring performance of the artificial neural network is to compare an inference result from input data with GT for the input data. However, in a general application case including a mobile communication system, it may be possible or difficult to acquire GT for input data depending on conditions, surroundings, or the like of the mobile communication system.

For example, a representative use case of an AI/ML item for a new radio (NR) air interface which is selected as a study item (SI) of Release 18 in the 3GPP standard is as follows.

First, in the case of AWL-based channel state information (CSI) feedback, when an AI/ML model is configured in an autoencoder manner, GT for input data becomes the input data, which may be a case where GT is obtainable. Meanwhile, in the case of AWL-based beam management, in the use case of estimating an unmeasured strength of received beams on the basis of a measured strength of received beams in a spatial area, GT, that is, an unmeasured strength of beams, is not acquirable.

Similarly, in the case of AI/ML-based positioning, GT for input data, that is, accurate location information, is not acquirable without an unrealistic assumption that a UE wirelessly communicates with a gNB at a promised location or the like.

Therefore, in the field of data science, discussions are ongoing on a method of estimating performance of an artificial neural network model without GT. For example, when there is low correlation between training data for an artificial neural network and measured data, performance degradation proportionate to the correlation may be estimated through a simple regression model. Since a function of monitoring performance of an artificial neural network model without GT requires additional complexity of implementation and additional calculation, whether the function is supported may vary depending on the capability of UE.

As described above, within a range in which the management method of the first example embodiment does not conflict with other management methods of other embodiments, the management method of the first example embodiment may be applied together.

### Second Example Embodiment

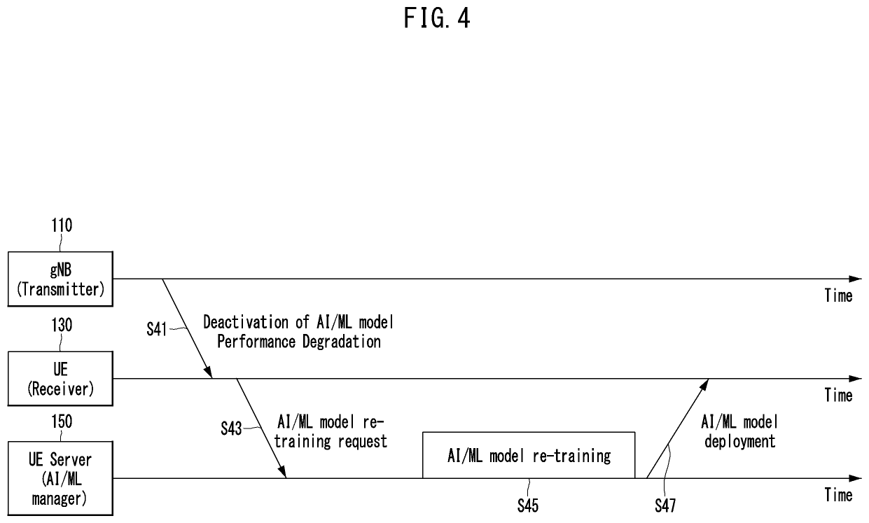

FIG. 4 is a conceptual diagram illustrating a model deactivation instruction and wireless transmission performance feedback process of a gNB that may be employed in a management method of the present disclosure.

According to a management method of this example embodiment, when an artificial neural network for wireless communication is applied to a mobile communication system including a gNB 110 and a UE 130 and the UE 130 may create and/or utilize one or more artificial neural networks for a specific function, the gNB 110 may instruct activation or deactivation of one of the artificial neural network models of the UE 130 for the specific function. When the gNB 110 instructs deactivation of the model, the gNB 110 may feed back at least one piece of the following information to the UE 130 as a reason for deactivation.

Details of information that may be included as a reason for deactivation may include at least one of no particular reason, the purpose of changing artificial neural networks, model performance degradation of the artificial neural network, and wireless transmission performance degradation.

Here, the model performance may be a performance metric of an inference operation based on the artificial neural network model. However, when there is no specific reason in the case of deactivation, the gNB 110 may only give a deactivation instruction and may not include any reason in the instruction. Here, the UE 130 may be implicatively aware that the artificial neural network has no performance issue. The wireless transmission performance may include a throughput, a block error rate (BLER), a modulation and coding scheme (MCS) level, and the like. Also, as a reason for deactivation of an AI/ML model, the gNB 110 may transmit a measure of performance degradation of the artificial neural network model or wireless transmission performance degradation to the UE 130 (S41).

As an example, in the mobile communication system including the gNB 110 and the UE 130, it is assumed that the UE 130 utilizes an artificial neural network for wireless communication. When an artificial neural network is used for wireless communication, model performance of the artificial neural network is an intermediate key performance indicator (KPI), and wireless transmission performance may ultimately be a final KPI. The wireless transmission performance may include a throughput, a BLER, an MCS level, a packet drop rate, and the like. The wireless transmission performance may be relatively accurately determined in the gNB 110 or an NW that directly instructs scheduling rather than the UE 130.

Therefore, when an artificial neural network is used for a specific function for wireless communication and wireless transmission performance is degraded due to the application of the artificial neural network compared to existing wireless transmission performance, the gNB 110 may easily detect the model performance degradation, but it may be difficult for the UE 130 to detect the model performance degradation.

Therefore, according to the management method of this example embodiment, when the UE 130 may create and/or utilize one or more artificial neural networks for a specific function, the gNB 110 may instruct activation or deactivation of one of the artificial neural networks of the UE 130 for the specific function and feed back at least one piece of the above information on reasons for deactivation to the UE 130 as a reason for deactivation.

The UE 130 may use the reason for deactivation to determine the necessity of retraining or tuning a UE-sided artificial neural network. When it is determined that it is necessary to retrain the UE-sided artificial neural network, the UE 130 may request AI/ML model retraining from a UE server 150 (S43).

As an AI/ML manager, the UE server 150 may perform AI/ML model retraining according to the AI/ML model retraining request (S45) and operate so that a retrained AI/ML model may be deployed in the UE 130 (S47).

Within a range in which the above-described management method of the second example embodiment does not conflict with other management methods of other embodiments of the present disclosure, the management method of the second example embodiment may be applied together.

### Third Example Embodiment

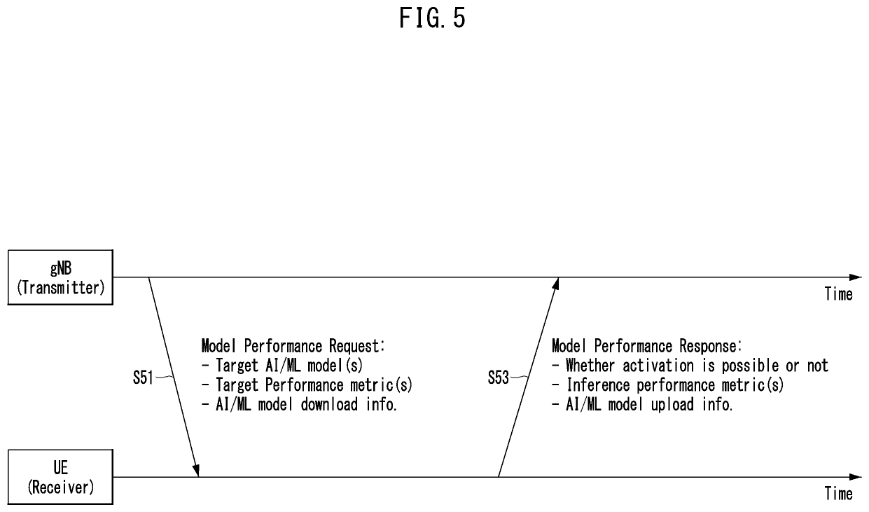

FIG. 5 is a conceptual diagram illustrating an artificial neural network model performance request and response process that may be employed in a management method of the present disclosure.

According to a management method of this example embodiment, when an artificial neural network for wireless communication is applied to a mobile communication system including a gNB and a UE and the UE may create and/or utilize one or more artificial neural networks for a specific function, the gNB may transmit a model performance request message for the specific function regarding the artificial neural networks of the UE to the UE (S51).

The model performance request may include at least one of information on artificial neural network models requiring a response, for example, target AI/ML model information, information on model performance metrics requiring a response, for example, target performance metric information, and information on an artificial neural network model directly set by the gNB, for example, AI/ML model download information.

Also, according to the management method, the UE may transmit a model performance response to the gNB in response to the model performance request from the gNB (S53).

The model performance response may include at least one of whether activation of each artificial neural network is possible, an inference performance metric of each artificial neural network, and information on an artificial neural network model of the UE referred to by the gNB, for example, AI/ML model upload information.

The above model performance or inference performance is a performance metric of an inference operation based on an artificial neural network model and may be a metric that the UE derives by acquiring GT for input data or a metric that the UE estimates itself without GT for input data.

Model activation and model deactivation may be utilizing and not utilizing an artificial neural network distributed to the UE for a specific function, respectively.

Also, according to the management method of this example embodiment, when a two-sided AI/ML model is used by the gNB and the UE, the gNB may transmit information on an artificial neural network model used for inference at the gNB to the UE or transmit a binary file in a form executable by the corresponding model to the UE to request inference performance from the UE. Further, the UE may report an inference process of the artificial neural network at the UE and artificial neural network model information at the gNB or report inference performance obtained by synthesizing an inference process based on a binary file in a form executable by the corresponding model.

As described above, assuming that, in a mobile communication system including a gNB and UE according to the 3GPP standard, the UE utilizes an artificial neural network for wireless communication, the gNB schedules a plurality of pieces of UE and comprehensively considers circumstances to select a wireless transmission technique in terms of maximizing a cell throughput. Here, even when the UE may utilize an artificial neural network for wireless communication, it may be preferable for the gNB to determine whether to apply the artificial neural network.

In other words, the gNB can supervise model activation and/or model deactivation for the artificial neural network. In general, the gNB expects an improvement in wireless transmission performance when an artificial neural network technique is applied instead of an existing algorithm. However, the artificial neural network technique is determined by training data, and thus a performance improvement compared to an existing algorithm is not always ensured.

Therefore, a process in which a gNB determines whether to utilize an artificial neural network model of UE for a specific function may be roughly classified into one of two types.

First, the gNB may utilize an artificial neural network model through trial and error. Specifically, when the UE reports an artificial neural network support capability for a specific function, the gNB may activate the corresponding artificial neural network with an expectation that performance will be improved. Subsequently, the gNB may monitor wireless transmission performance during an activation period of the artificial neural network and deactivate the artificial neural network when the wireless transmission performance is degraded. This management method has an advantage in that the procedure is simple but has a disadvantage in that the wireless transmission performance may be degraded every time the gNB attempts to activate the artificial neural network model in an environment in which performance of the artificial neural network is degraded, which is different from an environment for training.

Second, the gNB may request a report on model performance of an artificial neural network from the UE and then activate the artificial neural network on the basis of the report. For example, the gNB may receive a report on a model performance metric that is calculated or estimated by the UE, and activate the artificial neural network when the model performance metric is a certain level or higher. Subsequently, the gNB may monitor wireless transmission performance during an activation period of the artificial neural network and deactivate the artificial neural network when the wireless transmission performance is degraded.

The above management method has a disadvantage in that the procedure is complicated due to the corresponding operation added before model activation but has an advantage in that performance degradation is prevented by activating an artificial neural network in an environment where minimum model performance of the artificial neural network is ensured.

Therefore, according to the management method of this example embodiment, when an artificial neural network for wireless communication is applied to a mobile communication system including a gNB and UE and the UE may create and/or utilize one or more artificial neural networks for a specific function, the gNB may transmit a model performance request for the specific function regarding the artificial neural networks of the UE to the UE and receive a model performance response from the UE.

According to the most simplified form of the above-described configuration, when a gNB transmits a performance request for an artificial neural network to UE together with artificial neural network information requiring a response, the UE determines whether performance of the artificial neural network requested by the gNB is stable. When it is determined that the performance of the artificial neural network is stable, the UE reports to the gNB that it is possible to activate the artificial neural network, and when it is determined that the performance of the artificial neural network is unstable, the UE reports to the gNB that the artificial neural network is unstable or it is not possible to activate the artificial neural network. Here, the UE may report a model performance metric of the artificial neural network to the gNB so that the gNB can determine whether to activate the artificial neural network. The model performance metric of the artificial neural network may be a metric that is derived by the UE acquiring GT for input data or a metric that is estimated by the UE itself without GT for input data.

Within a range in which the above-described management method of the third example embodiment does not conflict with other management methods of other embodiments of the present disclosure, the management method of the third example embodiment may be applied together.

### Fourth Example Embodiment

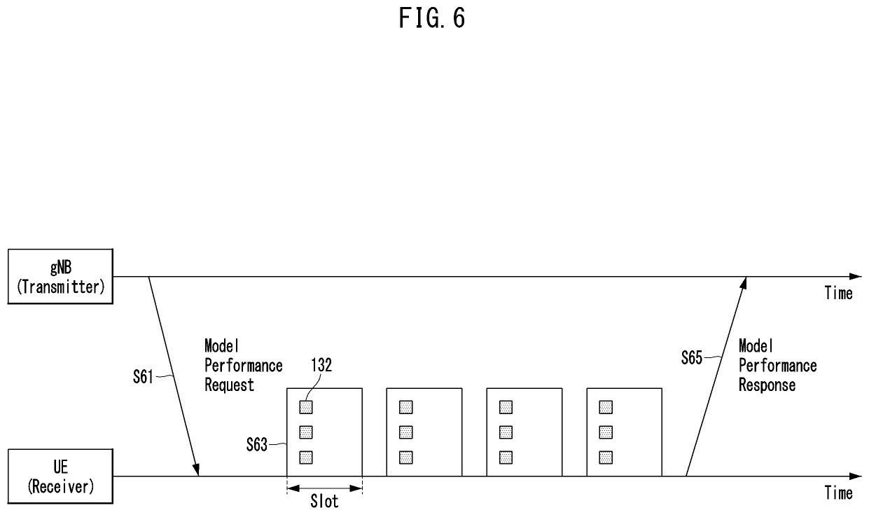

FIG. 6 is a conceptual diagram illustrating a process of transmitting measurement resources for acquiring GT when artificial neural network model performance is requested which may be employed in a management method of the present disclosure.

According to the management method of this example embodiment, when an artificial neural network for wireless communication is applied to a mobile communication system including a gNB and UE and the UE may provide an inference performance metric of an artificial neural network based on GT, the gNB may transmit one or more pieces of the following information to the UE as information on measurement resources for acquiring GT at the time of transmitting a model performance request for an artificial neural network of the UE to the UE (S61).
Time-axis resource allocation information of measurement resources for acquiring GT
Frequency-axis resource allocation information of measurement resources for acquiring GT
The number of repeated transmissions of measurement resources for acquiring GT

Also, according to the management method of this example embodiment, the UE may transmit a model performance response of the artificial neural network measured through measurement resources to the gNB in the form of a message including one of the following three reports (S65).
A report on performance at each of a plurality of transmission opportunities
A report on average performance at a plurality of transmission opportunities
A report on minimum and/or maximum performance at a plurality of transmission opportunities

Also, according to the management method of this example embodiment, the gNB may support burst transmission through consecutive slots when transmitting measurement resources 132 for acquiring GT to the UE (S63).

According to the above-described configuration, in a mobile communication system including a gNB and UE according to the 3GPP standard, when the UE utilizes an artificial neural network for wireless communication, the gNB may request a report on model performance of the artificial neural network from the UE and then activate the artificial neural network on the basis of the report. For example, the gNB may receive a report on a model performance metric that is calculated or estimated by the UE, and activate the artificial neural network when the model performance metric is a certain level or higher. Subsequently, the gNB may monitor wireless transmission performance during an activation period of the artificial neural network and deactivate the artificial neural network when the wireless transmission performance is degraded.

Meanwhile, when the gNB intends to receive an inference performance metric of the artificial neural network based on GT from the UE, it is necessary to ensure transmission of measurement resources for the UE to acquire GT. For example, when the UE performs CSI prediction on the time axis, the gNB is required to transmit CSI-reference signal (RS) resources as measurement resources so that the UE may acquire GT at a prediction point in time.

Therefore, in the case of periodically transmitting GT measurement resources, the gNB's load of RS transmission increases. Accordingly, GT measurement resources may be transmitted only at a plurality of opportunities arranged between the eNB and the UE. For example, when the UE performs CSI prediction on the time axis, the gNB may repeatedly transmit a CSI-RS for acquiring GT five times, and the UE may obtain five data pairs of input data and GT at the five transmission opportunities.

Subsequently, the UE may report model performance of the artificial neural network measured through the measurement resources as performance at each transmission opportunity or in view of average, minimum, and maximum performance. The gNB may determine whether to activate or deactivate the artificial neural network on the basis of model performance of the artificial neural network in a snapshot reported by the UE.

As another example, when an entire beam group is divided into a first beam group and a second beam group in a wireless communication system based on beams, such as millimeter waves or the like, and a UE intends to estimate a measurement value of the second beam group from a measurement value of the first beam group using an artificial neural network, a gNB may transmit measurement resources for only the first beam group in a period in which the UE performs a general inference operation, and may transmit measurement resources for both the first beam group and the second beam group in a period in which it is necessary to acquire GT for performance measurement of the artificial neural network at the UE. Also, to reduce a time for acquiring GT, the UE may transmit the GT measurement resources 132 to the UE in consecutive slots through a burst transmission.

Within a range in which the above-described management method of this example embodiment does not conflict with other management methods of other embodiments of the present disclosure, the management method of this example embodiment may be applied together.

### Example Embodiment 4-1

A management method of this example embodiment may include, when an artificial neural network for wireless communication is applied to a mobile communication system including a gNB and UE, an operation in which the gNB requests GT measured by the UE from the UE.

Specifically, when the UE encodes CSI information using an artificial neural network-based encoder, the gNB decodes the CSI using an artificial neural network-based decoder, and the pair of an artificial neural network encoder and decoder operate in an autoencoder manner, the gNB may request that the UE report input data for the artificial neural network encoder as GT for the purpose of evaluating performance of the autoencoder. Here, the GT may be reported together with CSI feedback information.

More specifically, for example, it may be assumed that a UE may utilize an artificial neural network for wireless communication in a mobile communication system including a gNB and the UE according to the 3GPP standard. In this case, according to a two-sided AUML model structure, the UE with an artificial neural network-based encoder and the gNB with an artificial neural network-based decoder may perform an artificial neural network-based CSI feedback process. When the two-sided AUML model structure is an autoencoder structure, GT may be input data for the artificial neural network encoder at the UE during training or performance evaluation of the artificial neural network model. Here, the gNB may request that the UE report the input data for the artificial neural network encoder as GT for the purpose of evaluating performance of the autoencoder. Through a dynamic control signal, the gNB may instruct the UE to aperiodically report GT or to report GT together with existing periodic CSI feedback resources at the same or longer intervals.

Within a range in which the above-described management method of this example embodiment does not conflict with other management methods of other embodiments of the present disclosure, the management method of this example embodiment may be applied together.

### Fifth Example Embodiment

A management method of this example embodiment may include, when an artificial neural network for wireless communication is applied to a mobile communication system including a gNB and UE and the UE infers channel information for a specific point in time on the basis of the artificial neural network using one or more measurement resources and reports the channel information to the gNB, an operation of allowing measurement resources received within a certain time window from the specific point in time at which the channel information is inferred to be used for acquiring GT for the channel information inference.

According to the management method, when the gNB instructs or sets a future point in time to infer channel information to the UE, the gNB may express the future point in time as an offset based on a report point in time for the UE to report the channel information and transmit the future point in time to the UE. This is because a point in time for the UE to measure channel information is not clear according to implementation characteristics, whereas a point in time for the UE to report channel information is relatively clear.

For example, it may be assumed that a UE may utilize an artificial neural network for wireless communication in a mobile communication system including a gNB and the UE according to the 3GPP standard. More specifically, the UE may be assumed to perform an operation of predicting CSI for a future point in time using the artificial neural network. In this case, when it is intended to monitor model performance of the CSI prediction artificial neural network of the UE, strictly speaking, when CSI measurement resources, such as a CSI-RS, a CSI-interference measurement (IM), and the like, are provided from the gNB to the UE at a point in time for the UE to predict CSI, the UE is required to acquire channel information for the corresponding point in time as GT.

However, in some cases, it may be difficult for the gNB to transmit CSI measurement resources at that exact point in time. For example, in a time-division duplexing (TDD) system or the like in which downlink slots and uplink slots coexist at a ratio of 4:1, a slot of a point in time at which the UE predicts CSI may be an uplink slot.

Therefore, the management method of this example embodiment may include an operation of allowing, when the UE infers channel information for a specific point in time using one or more measurement resources on the basis of an artificial neural network to reflect the above realistic constraints and reports the channel information to the gNB, measurement resources received within a certain time window from a specific point in time at which the channel information is inferred to be used for acquiring GT for the channel information inference.

For example, in an example of predicting CSI, the management method may include an operation of allowing the UE to use CSI measurement resources received within five slots preceding or following a CSI prediction point in time for the purpose of acquiring GT.

Within a range in which the above-described management method of this example embodiment does not conflict with other management methods of other embodiments of the present disclosure, the management method of this example embodiment may be applied together.

### Sixth Example Embodiment

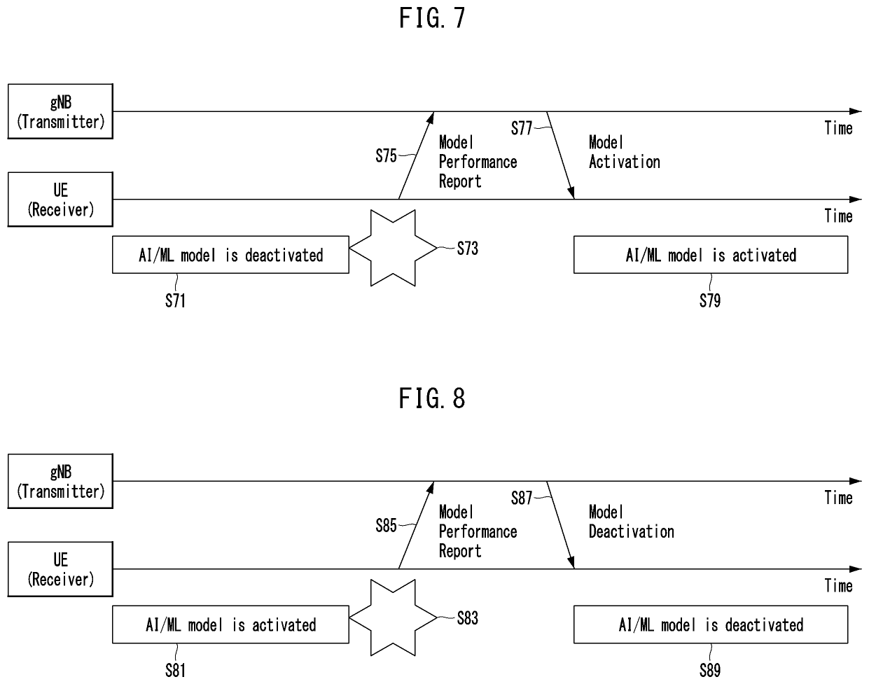

FIG. 7 is a conceptual diagram illustrating an event-based artificial neural network model performance report process that may be employed in a management method of the present disclosure. Also, FIG. 8 is a conceptual diagram illustrating another event-based artificial neural network model performance report process that may be employed in a management method of the present disclosure.

According to the management method of this example embodiment, when an artificial neural network for wireless communication is applied to a mobile communication system including a gNB and UE and the UE may create and/or utilize at least one artificial neural network for a specific function, the gNB may differentially set trigger conditions for a model performance report of an artificial neural network for the specific function to the UE according to whether the artificial neural network is activated or deactivated as follows.

In other words, as shown in FIG. 7, when an AI/ML model of the UE is deactivated (S71) and model performance of the artificial neural network model in the UE is a first reference value or more, that is, when there is an event of an inference performance increase (S73), the gNB may determine that activation of the artificial neural network model is triggered by an artificial neural network model performance report from the UE (S75) and transmit a signal or message for artificial neural network model activation to the UE (S77). Accordingly, the AI/ML model of the UE may be activated (S79).

Also, as shown in FIG. 8, when the AI/ML model of the UE is activated (S81) and model performance of the artificial neural network in the UE is a second reference value or less, that is, when there is an event of an inference performance decrease (S83), the gNB may determine that deactivation of the artificial neural network model is triggered by an artificial neural network model performance report from the UE (S85) and transmit a signal or message for artificial neural network model deactivation to the UE (S87). Accordingly, the AI/ML model of the UE may be deactivated (S89).

The first reference value and the second reference value may be set to the same value or set to different values to prevent a ping-pong effect.

Also, according to the management method of this example embodiment, when a trigger condition of the UE is satisfied, the UE may report model performance of a specific artificial neural network for a specific function including one or more pieces of the following trigger-based information to the gNB. The trigger-based information may include whether a trigger event occurs, a model performance metric of an artificial neural network, a recommendation to activate an artificial neural network model, a recommendation to deactivate an artificial neural network model, or the like.

Also, according to the management method of this example embodiment, the UE may transmit model performance of an artificial neural network to the gNB using at least one of the following transmission methods. The transmission methods may include a physical layer control channel, a control element (CE), radio resource control (RRC) signaling, and the like. Here, the physical layer control channel may include uplink control information (UCI) and the like of a physical uplink control channel (PUCCH) and a physical uplink shared channel (PUSCH). The CE may include a media access control (MAC) CE and the like, and the RRC signaling may include UE assistance information and the like.

Also, according to the management method of this example embodiment, the UE may report performance of a plurality of artificial neural networks to the gNB. In this case, the UE may provide a model performance metric of each artificial neural network to the gNB. Here, the gNB may select one of the plurality of artificial neural networks with reference to the model performance metrics of the artificial neural networks and then instruct the UE to activate the selected artificial neural network.

In the above-described embodiment, it may be assumed that a UE utilizes an artificial neural network for wireless communication in a mobile communication system including a gNB and the UE according to the 3GPP standard. In this case, as described above in the other management methods of the present disclosure, the gNB may request a report on model performance of the artificial neural network from the UE and then activate the artificial neural network on the basis of the report. However, according to the above management method, it is necessary to request a report on model performance of an artificial neural network from a UE every time a gNB intends to activate the artificial neural network, and thus the load of signal transmission for performance report requests increases.

To prevent this problem, according to the management method of this example embodiment, the gNB may differentially set trigger conditions for a model performance report of an artificial neural network for the specific function to the UE according to whether the artificial neural network is activated or deactivated as follows. Also, when the trigger condition is satisfied in the UE, the UE may report model performance of the specific artificial neural network for the specific function including one or more pieces of the above trigger-based information to the gNB.

As an example, the gNB may define or set a related operation of the UE so that the UE transmits a performance report to the gNB when the artificial neural network model of the UE is currently deactivated and model performance of the artificial neural network of the UE is the first reference value or more. Subsequently, when the preset trigger condition is satisfied, the UE may recommend that the gNB activate the artificial neural network model.

As another example, the gNB may define or set a related operation of the UE so that the UE transmits a performance report to the gNB when the artificial neural network model of the UE is currently activated and model performance of the artificial neural network of the UE is the second reference value or less. Subsequently, when the preset trigger condition is satisfied, the UE may recommend that the gNB deactivate the artificial neural network model.

Within a range in which the above-described management method of this example embodiment does not conflict with other management methods of other embodiments of the present disclosure, the management method of this example embodiment may be applied together.

### Seventh Example Embodiment

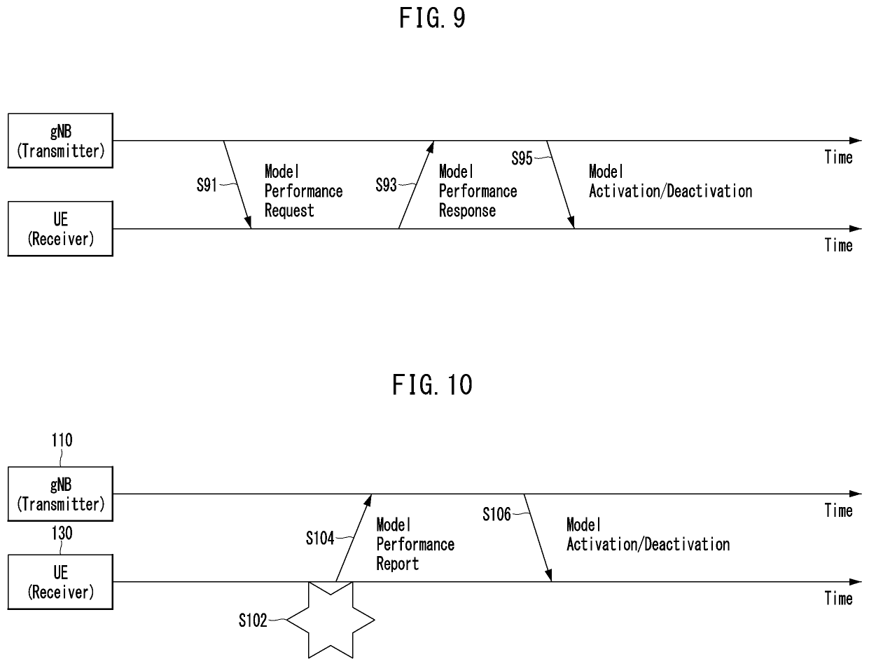

FIG. 9 is a conceptual diagram illustrating a process that may be employed in a management method of the present disclosure in which a gNB or UE triggers activation or deactivation of an artificial neural network model. Also, FIG. 10 is a conceptual diagram illustrating another process that may be employed in a management method of the present disclosure in which a gNB or UE triggers activation or deactivation of an artificial neural network model.

A management method of this example embodiment may include, when an artificial neural network for wireless communication is applied to a mobile communication system including a gNB and UE and the UE may create and/or utilize at least one artificial neural network for a specific function, an operation in which the gNB or the UE triggers activation or deactivation of an artificial neural network model for the specific function.

First, the management method including a method in which the gNB triggers model activation or model deactivation may include, as shown in FIG. 9, an operation S91 in which the gNB transmits a model performance request to the UE, an operation S93 in which the UE transmits a model performance response to the gNB, and an operation S95 in which the gNB instructs the UE to activate or deactivate the model.

Meanwhile, the management method including a method in which the UE triggers model activation or model deactivation may include, as shown in FIG. 10, an operation S102 in which a trigger event for a model performance report is set or defined in advance between the UE and the gNB, an operation S104 in which the UE transmits a model performance report to the gNB when the event occurs, and an operation S106 in which the gNB instructs the UE to activate or deactivate the model.

Here, according to the management method, when the gNB intends to receive a report on a model performance metric of an artificial neural network based on GT from the UE in a model performance request process, the gNB may set and transmit measurement resources for acquiring GT.

Also, when the gNB requests model performance from the UE and waits for a response, the gNB may arrange or set a timer or a time window for waiting for a response in advance with the UE. Subsequently, when it is possible to respond to the request for model performance of the UE, the UE may transmit a response to the gNB before the timer or the time window expires. When no response is received within a preset operating time of the timer of the preset time window, the gNB may determine that it is not possible to activate the artificial neural network model in the UE.

In the above-described embodiment, it may be assumed that a UE utilizes an artificial neural network for wireless communication in a mobile communication system including a gNB and the UE according to the 3GPP standard. Here, according to the management method, in a procedure for determining whether to activate or deactivate the artificial neural network model after performance of the artificial neural network model is determined, a report on model performance of the artificial neural network of the UE may be triggered by the gNB or the UE.

First, when the gNB triggers model activation or deactivation, the gNB may transmit a model performance request to the UE (S91), the UE may transmit a model performance response to the gNB in response to the model performance request (S93), and the gNB may transmit a model activation or deactivation instruction to the UE on the basis of the model performance response of the UE (S95).

Second, when the UE triggers model activation or deactivation, a trigger event for a model performance report may be set or defined in advance between the UE and the gNB. When the event occurs (S102), the UE may report model performance to the gNB (S104), and the gNB may instruct the UE to activate or deactivate the model on the basis of the model performance report of the UE (S106).

Here, when the gNB intends to receive a report on a model performance metric of the artificial neural network based on GT from the UE in a model performance request process, the gNB may set and transmit measurement resources for acquiring GT. Also, when the gNB requests model performance from the UE and waits for a response, the gNB may arrange or set a timer or a time window for waiting for a response in advance with the UE.

Subsequently, when it is possible to respond to the request for model performance, the UE may transmit a response to the gNB before the timer or the time window expires. When no response is received within a preset operating time of the timer of the preset time window, the gNB may determine that it is not possible to activate the artificial neural network model in the UE.

Within a range in which the management method of this example embodiment does not conflict with other management methods of other embodiments of the present disclosure, the management method of this example embodiment may be applied together.

### Eighth Example Embodiment

A management method of this example embodiment may include, when an artificial neural network for wireless communication is applied to a mobile communication system including a gNB and UE and the UE provides an inference performance metric of the artificial neural network not based on GT, an operation of reporting validity measure information of a training dataset as an inference performance metric of the artificial neural network not based on GT to the gNB in the form of any one of dataset similarity between the training dataset and a measured dataset, statistical distance between the distribution of the training data and the distribution of measured data, similarity between the training dataset and individual input data, and whether data drift occurs.

The dataset similarity between the training dataset and the measured dataset may include dataset similarity that is measured using at least one of proxy A-distance (PAD), maximum mean discrepancy (MMD), and optimal transport dataset distance (OTDD).

The statistical distance between the distribution of the training data and the distribution of measured data may include statistical distance that is calculated using at least one of a Kullback-Leibler divergence (KLD), a population stability index (PSI), a Kolmogorov-Smirnov (KS) test, a Jensen-Shannon divergence (JSD), a Wasserstein distance or earth mover's distance (EMD), and summary statistics.

The similarity between the training dataset and individual input data may include a Z-score.

According to the above-described management method of the example embodiment, when the UE supports a plurality of artificial neural network models, a validity measure of a training dataset may be transmitted from the UE to the gNB in a form preset for each artificial neural network. To this end, the gNB may transmit settings related to transmission resources and a transmission method for reporting validity measure information of a training dataset to the UE.

In the above-described embodiment, it may be assumed that a UE utilizes an artificial neural network for wireless communication in a mobile communication system including a gNB and the UE according to the 3GPP standard. When the distribution of training data which is used for training the artificial neural network by the UE becomes different from that of data for inference measured in a real general environment, data drift may occur, and accordingly, performance of the artificial neural network model may be significantly degraded. Therefore, according to the management method of this example embodiment, the UE may report to the gNB at least whether data drift occurs, and the gNB may rapidly deactivate a problematic artificial neural network. Also, the UE may report a validity measure of a training dataset to the gNB as an indirect indicator of a model performance metric of the artificial neural network. Validity of a training dataset may be expressed as dataset similarity with a measured dataset or statistical distance from the measured dataset.

A metric for measuring similarity between datasets or data will be briefly defined below.

First, PAD is defined according to the following methodology. Source and target datasets are mixed, and labels are specified according to origins of samples. For example, a first dataset may be specified with 0, and a second dataset may be specified with 1. After that, a domain classifier is trained using the mixed data and tested using a test set, and an error obtained as a test result is recorded. The above-described PAD may be defined according to Equation 1 below.

d_{A}=2(2−2ϵ) [Equation 1]

MMD represents the distance between different probability distributions as the distance between average embeddings for features. When there are two probability distributions P and Q of two probability variables X and Y and an embedding function or feature mapping function φ is given, the above-described MMD may be defined according to Equation 2 below.

MMD(P,Q)=∥E_{X·P}[(X)]−E_{Y˜Q}[(Y)]∥ [Equation 2]

OTDD is a metric representing the cost of a conversion when the distribution of the probability variable X is converted similar to the distribution of the probability variable Y. The cost may be given as the distance in Euclidean space. When the two probability variables X and Y are defined in a probability space X, there are the probability distributions P and Q for the probability variables X and Y, and a cost function c(x, y) is given, an OTDD may be defined according to Equation 3 below.

$$O T ( P , Q ) = {min}_{π ∈ \prod ( P , Q )} {\int }_{χ \times χ} c ( x , y ) d π ( x , y ) \qquad [ Equation 3 ]$$

A KLD is a function used for calculating the difference between two probability distributions, that is, calculating information entropy difference that may be caused by sampling a distribution approximate to a certain ideal distribution instead of the ideal distribution. When there are probability distributions P and Q of two probability variables, the above-described KLD (DKL) may be defined according to Equation 4 below.

$${D}_{K L} ( P , Q ) = H ( P , Q ) - H ( P ) = {\int }_{- ∞}^{∞} P ( x ) log \frac{p ( x )}{q ( x )} d x \qquad [ Equation 4 ]$$

A PSI is an index representing the stability of a population, that is, the difference between a current distribution and a distribution at a reference point in time, and may be defined according to Equation 5 below.

$$P S I = \sum ( ( Actual \% - Expected \% ) \times ln ( \frac{Actual \%}{Expected \%} ) ) \qquad [ Equation 5 ]$$

A KS test is a technique for comparing the distance between the empirical distribution functions of two probability variables with a specific reference and may be defined as the largest value of the difference between cumulative distribution functions (CDFs).

A JSD is a function used for calculating the difference between probability distributions and corresponds to a mitigated version of a KLD.

An EMD represents the amount of work required for changing a histogram of a probability variable X to be the same as a histogram of a random variable Y.

Summary statistics may compare averages and distributions of two probability distributions to compare the difference between the two distributions.

AZ-score is a standardized score that shows how much a measured value deviates from the mean when a standard deviation is used as a unit, and may be defined according to Equation 6 below.

$$Z = \frac{score - mean}{standard deviation} \qquad [ Equation 6 ]$$

Within a range in which the management method of this example embodiment does not conflict with other management methods of other embodiments of the present disclosure, the management method of this example embodiment may be applied together.

### Ninth Example Embodiment

According to a management method of this example embodiment, when an artificial neural network for wireless communication is applied to a mobile communication system including a gNB and UE and the UE compares a training dataset with a measured dataset and reports validity measure information of the training dataset to the gNB, the UE may report at least one piece of the following information to the gNB as ID information of the measured dataset together with the validity measure information of the training dataset.

The ID information of the measured dataset may include a public land mobile network (PLMN) ID, a base station ID (e.g., an evolved node base station (eNB) ID or a gNB ID), a cell ID, a transmission and reception point (TRP) ID, an RS ID of a downlink or the like, a mobility management entity (MME) ID (e.g., a global unique MME ID (GUMMEI)), a tracking area (TA) ID (e.g., tracking area identity (TAI)), a tracking area code (TAC), and the like.

Also, according to the management method, the gNB may transmit settings related to transmission resources and a transmission method for reporting ID information of a measured region to the UE.

According to the management method of this example embodiment, it may be assumed that a UE utilizes an artificial neural network for wireless communication in a mobile communication system including a gNB and the UE according to the 3GPP standard. Here, the UE may report a validity measure of a training dataset to the gNB as an indirect indicator of a model performance metric of the artificial neural network. For example, validity of a training dataset may be expressed as dataset similarity with a measured dataset or statistical distance from the measured dataset. When the UE may collect measured datasets by region, reporting region information in which the similarity between a training dataset and a measured dataset decreases to the gNB may help the gNB determine whether to use the artificial neural network.

Also, for example, when there are a plurality of TRPs in a cell and the UE may manage measured datasets by TRP, the UE may determine validity of training data in TRP units and report TRP IDs corresponding to valid training data or TRP IDs corresponding to invalid training data to the gNB. On the basis of the report of the UE, the gNB may activate the artificial neural network of the UE for a TRP corresponding to valid training data and deactivate the artificial neural network of the UE for a TRP corresponding to invalid training data.

Within a range in which the management method of this example embodiment does not conflict with other management methods of other embodiments of the present disclosure, the management method of this example embodiment may be applied together.

### Tenth Example Embodiment

According to a management method of this example embodiment, when an artificial neural network for wireless communication is applied to a mobile communication system including a gNB and UE and the UE may create and/or utilize one or more artificial neural networks for a specific function, the UE may report a performance metric of the artificial neural network to the gNB, and in this case, the UE may classify channel environments into a plurality of categories and report performance of the artificial neural network for each category of channel environment to the gNB.

For example, the UE may report a performance metric of the artificial neural network for each channel environment or channel period using at least one of reference signal received power (RSRP), reference signal received quality (RSRQ), a received signal strength indicator (RSSI), a signal-to-interference ratio (SINR), a channel quality indicator (CQI), a rank index (RI), and a modulation coding scheme (MCS).

According to the management method of this example embodiment, it may be assumed that a UE utilizes an artificial neural network for wireless communication in a mobile communication system including a gNB and the UE according to the 3GPP standard. Here, performance of the artificial neural network of the UE may depend on a wireless channel environment. For example, the UE may be assumed to compress channel information into CSI information using the artificial neural network. In this case, the artificial neural network may show high performance in an environment in which receive sensitivity is high and channel estimation is accurate because the UE is at the center of a cell. However, the performance may be degraded in an environment in which receive sensitivity is poor and channel estimation is inaccurate because the UE is at a cell boundary. Here, the UE may classify channel environments into a plurality of categories and report performance for each category of channel environment. Then, the gNB may utilize the artificial neural network when the artificial neural network shows high performance in a current channel environment of the UE, and may not utilize the artificial neural network otherwise.

According to this example embodiment, the management method allows a gNB to selectively not utilize an artificial neural network in a channel environment in which performance benefit of the artificial neural network is relatively little, and thus it is possible to reduce costs of signal transmission, calculation, and the like caused by utilizing the artificial neural network.

Within a range in which the management method of this example embodiment does not conflict with other management methods of other embodiments of the present disclosure, the management method of this example embodiment may be applied together.

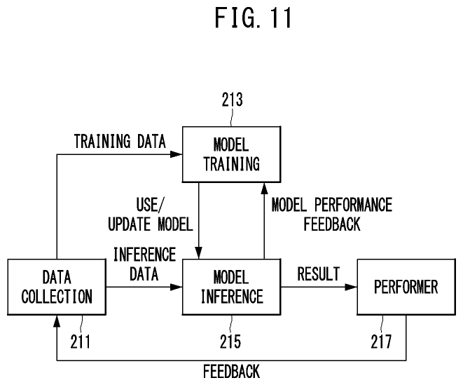

FIG. 11 is a block diagram illustrating a random access network (RAN) intellectualization function of an artificial neural network which may be employed in a management method of the present disclosure.

Referring to FIG. 11, an RAN intellectualization function structure for improving a self-organizing network (SON)/minimizing driver test (MDT) may include a data collector 211, a model trainer 213, a model inference part 215, and a performer 217.

The data collector 211 provides input data, such as training data, inference data, and the like, to the model trainer 213 and the model inference part 215. The input data may include a measurement value and the like from UE or other network entities.

The model trainer 213 may receive the training data from the data collector 211 and train, check, and test an ML model. Also, the model trainer 213 may prepare data required for training.

The model inference part 215 may provide a result from model inference, such as a prediction, a determination, or the like, to the performer 217. To this end, the model inference part 215 may make an inference from the inference data received from the data collector 211 using the model of the model trainer 213. Also, the model inference part 215 may receive a model update from the model trainer 213 or provide model performance feedback to the model trainer 213.

The performer 217 may receive the result from the model inference part 215 and perform an operation according to the result.

There may be roughly three types of use cases of AI in the above RAN intellectualization function structure.

The first type of case is network energy saving. A frequency band considered in fifth generation (5G) is relatively high, and thus 5G requires a larger number of gNBs than fourth generation (4G). Accordingly, power consumption of an NW as well as UE may become an issue. Therefore, it is possible to reduce power consumption of an NW by deactivating an unnecessary cell according to the traffic situations of cells, and in this case, an AWL-based cell management method can be applied.

The second type of case is traffic distribution. When a plurality of cells overlap and traffic is concentrated in one of the cells, a smooth mobile data service can be provided by distributing the traffic to other cells through AI/ML.

The last type of case is mobility optimization. With a decrease in cell size in 5G, the number of handovers between cells necessarily increases. Therefore, AWL-based performance monitoring and management can be used as a method of reducing unnecessary handovers while maintaining service continuity.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of monitoring and managing performance of an artificial neural network model for an air interface, the method comprising:
receiving, by a network (NW) including a communication node performing a function of monitoring and managing performance of an artificial neural network model, a performance metric of the artificial neural network model from a user equipment (UE); and
controlling, by the communication node, activation or deactivation of the artificial neural network model according to the performance metric,
wherein the artificial neural network model is activated to improve a main performance metric of a mobile communication system including the communication node and the UE connected through an air interface.

2. The method of claim 1, wherein the UE estimates performance of the artificial neural network model using an optimal transport dataset distance (OTDD).

3. The method of claim 1, further comprising acquiring a model inference performance report capability of the artificial neural network model from the UE.

4. The method of claim 3, wherein the acquiring of the model inference performance report capability comprises receiving information representing the model inference performance report capability or information representing that the artificial neural network model has a model inference performance report function from the UE.

5. The method of claim 3, further comprising selectively requesting a performance metric report of the artificial neural network model based on ground truth (GT) or not based on the GT from the UE with reference to the model inference performance report capability according to whether the UE uses the GT in evaluating model inference performance.

6. The method of claim 1, wherein the receiving of the performance metric comprises receiving a validity measure of a training dataset for the artificial neural network model as a performance metric of the artificial neural network model.

7. The method of claim 1, further comprising, before the receiving of the performance metric, repeatedly transmitting ground truth (GT) measurement resources for evaluating inference performance of the artificial neural network model to the UE,
wherein the receiving of the performance metric comprises receiving a performance metric of the artificial neural network model measured at a plurality of transmission opportunities to use the GT measurement resources.

8. The method of claim 7, further comprising receiving information on UE performance estimated on the basis of the inference performance of the artificial neural network model from the UE.

9. The method of claim 1, further comprising requesting a performance metric report of the artificial neural network model from the UE.

10. The method of claim 9, wherein the requesting of the performance metric report is performed by the communication node when a trigger condition is preset between the NW or the communication node and the UE and the trigger condition is satisfied because performance of the artificial neural network model rises to or above a certain level or falls to or below the certain level.

11. The method of claim 1, further comprising receiving a performance metric report of the artificial neural network model or a recommendation to activate or deactivate the artificial neural network model from the UE when a trigger condition is preset between the NW or the communication node and the UE and the trigger condition is satisfied because performance of the artificial neural network model rises to or above a certain level or falls to or below the certain level.

12. The object transmission method of claim 11, wherein the controlling of the activation or deactivation of the artificial neural network model comprises controlling the activation or deactivation of the artificial neural network model in response to the performance metric report or the recommendation to activate or deactivate the artificial neural network model.

13. The object transmission method of claim 11, wherein the trigger condition is differentially set according to whether the artificial neural network model is activated or deactivated.

14. An apparatus for monitoring and managing performance of an artificial neural network model for an air interface, the apparatus comprising a processor installed in a communication node connected to a user equipment (UE) through an air interface and configured to execute a program command for monitoring and managing performance of an artificial neural network model,
wherein the processor performs, according to the program command, operations of:
receiving a performance metric of the artificial neural network model from the UE; and
controlling activation or deactivation of the artificial neural network model according to the performance metric, and
the artificial neural network model is activated to improve a main performance metric of a network (NW) or a mobile communication system including the communication node and the UE connected through the air interface.

15. The apparatus of claim 14, wherein the processor further performs an operation of acquiring a model inference performance report capability of the artificial neural network model from the UE,
wherein the operation of acquiring the model inference performance report capability comprises receiving information representing the model inference performance report capability or information representing that the artificial neural network model has a model inference performance report function from the UE.

16. The apparatus of claim 15, wherein the processor further performs an operation of determining whether the UE uses ground truth (GT) in evaluating model inference performance with reference to the model inference performance report capability and selectively requesting a performance metric report of the artificial neural network model based on the GT or not based on the GT from the UE.

17. The apparatus of claim 14, wherein, in the operation of receiving the performance metric, the processor receives a validity measure of a training dataset for the artificial neural network model as a performance metric of the artificial neural network model.

18. The apparatus of claim 14, wherein, before the operation of receiving the performance metric, the processor further performs an operation of repeatedly transmitting ground truth (GT) measurement resources for evaluating inference performance of the artificial neural network model to the UE,
wherein, in the operation of receiving the performance metric, the processor receives a performance metric of the artificial neural network model measured at a plurality of transmission opportunities to use the GT measurement resources.

19. The apparatus of claim 14, wherein the processor further performs an operation of requesting a performance metric report of the artificial neural network model from the UE,
wherein the operation of requesting the performance metric report is performed by the communication node when a trigger condition is preset between the NW or the communication node and the UE and the trigger condition is satisfied because performance of the artificial neural network model rises to or above a certain level or falls to or below the certain level.

20. The apparatus of claim 14, wherein the processor further performs an operation of receiving a performance metric report of the artificial neural network model or a recommendation to activate or deactivate the artificial neural network model from the UE when a trigger condition is preset between the NW or the communication node and the UE and the trigger condition is satisfied because performance of the artificial neural network model rises to or above a certain level or falls to or below the certain level, and
in the operation of controlling the activation or deactivation of the artificial neural network model, the processor controls the activation or deactivation of the artificial neural network model in response to the performance metric report or the recommendation to activate or deactivate the artificial neural network model.
